(19) United States
(12) Patent Application Publication
(10) Pub. No.: US 2013/0052419 A1
(43) Pub. Date: Feb. 28, 2013

(54) HEAT-MANAGEMENT STRUCTURES WITH IMAGES

(71) Applicants: STEVEN YIALIZIS, Tucson, AZ (US); ANGELO YIALIZIS, Tucson, AZ (US)

(72) Inventors: STEVEN YIALIZIS, Tucson, AZ (US); ANGELO YIALIZIS, Tucson, AZ (US)

(73) Assignee: Sigma Laboratories of Arizona, LLC., Tucson, AZ (US)

(21) Appl. No.: 13/215,516

(22) Filed: Aug. 23, 2011

(51) Int. Cl. B32B 3/10; B05D 3/00; B32B 3/30; B32B 5/02; B32B 3/00

(52) U.S. Cl. 428/142; 428/201; 428/196; 428/172; 427/271

(57) ABSTRACT

Radiant-barrier structures include visible images that do not materially alter the emissivity and reflective quality of the barrier. The images are formed either below the reflective metallic layer or on top of the protective layer of the barrier used in commercial and residential construction applications, apparel, tents and other heat-management applications. The images may contain product and application information as well as visual effects with functional and/or decorative value. In some radiant-barrier embodiments the image-forming process enhances the radiant-barrier performance by lowering the surface emissivity.

### BACKGROUND OF THE INVENTION

1. Field of the Invention

This invention is related in general to heat-reflective materials and radiant barriers used for heat management purposes. Specifically, the invention addresses the formation of radiant-barrier structures that have a visible functional image on their surface.

2. Description of the Related Art

Metallized films and aluminum foils used to reflect heat are referred to herein as radiant barriers. The degree of heat reflection is usually measured by measuring the emissivity of the radiant barrier, which varies between one and zero, where zero represents 100% reflection and one represents 100% absorption. The terms emissivity and reflection are used interchangeably herein because they both relate to the objective of the invention, which is directed to the formation of images on the surface of a radiant barrier that retains high reflection of radiation and low emissivity.

Visible images on radiant-barrier structures may be desirable on all or part of the surface of the radiant-barrier material for various purposes, including, without limitation, conveying product and application information, product authentication, and providing decorative effects and/or marketing information. Depending on the heat-management application and the nature of the radiant-barrier material, such visual images need to be formed in a manner that does not have a significant effect on the properties of the radiant barrier, such as flexibility, emissivity, and moisture and vapor transmission. Ideally, such image-bearing structures could even be designed to improve the performance of the radiant barrier by lowering emissivity and/or increasing heat reflection.

Given that radiant barrier products are used in a broad range of applications, it would be advantageous to be able to print information (such as directions, company logos, and decorative patterns) on the sheet surface to differentiate the product from the competition. The problem is that any printing on the reflective surface will increase the emissivity value. As a result, in applications such as commercial and residential housing, a limit of 0.1% coverage by a printed ink has been set in the industry for the surface of a radiant-barrier sheet in order to maximize the functional value of radiant barriers.

This invention is directed to a novel approach that allows the formation of highly visible images on any portion or even all of the surface of a radiant-barrier sheet with no significant effect on its emissivity values. Furthermore, depending on the type of substrate used to produce the radiant-barrier material, certain image structures can even improve the radiant-barrier properties by lowering the emissivity on the image surface.

### BRIEF SUMMARY OF THE INVENTION

In view of the foregoing, this invention is directed to the production of metallized radiant-barrier materials with visible information in the form of application directions, shapes, logos and other useful images without a material increase in the emissivity of the material. Some of the image-producing processes of the invention, when combined with particular substrates, can actually reduce the emissivity of the surface. All radiant-barrier and reflective insulation applications, including but not limited to building and construction, window coverings and films, automotive, marine, aerospace, and consumer and industrial apparel are intended to be covered.

Generally a radiant-barrier material is understood to include a substrate, a thin metal layer deposited on the substrate, and a protective polymer layer deposited on the metal layer. However, the invention is applicable as well to various other radiant-barrier structures such as, for example, where the substrate is coated prior to metallization, or the metallization process includes steps designed to improve the corrosion resistance of the metal layer, or the protective polymer layer is treated to provide additional functionality such as hydrophobicity or anti-bacterial and anti-fungi properties.

According to one aspect of the invention, we discovered that an image created by printing on a substrate and subsequently covered by a reflective metal layer can surprisingly be identified as an image on the opposite side of the opaque metal layer by virtue of surface contrast produced by the printed regions. For most substrate materials, when an image is printed on the substrate surface, subsequent metallization creates a contrast-based image between the metallized substrate and the metallized printed surface without an increase in emissivity. The printed image is made visible after metallization both by the difference in the finish produced by the printed layer and by the contrast at the edge of the printed surface. Positive or negative images may be created in this manner, a positive image being one where the image is represented by the printed surface and a negative image one where the substrate is printed everywhere except in the areas that define the image.

According to another aspect of the invention, the printed coating may also have a textured surface, a hologram or a diffraction grating that creates a color shifting effect when metallized. Such images may be used for product authentication and decorative purposes.

According to yet another aspect of the invention, the images are embossed, rather than printed, onto the substrate prior to metallization. The image forming process may be accomplished using conventional cold or hot embossing methods that produce permanent flat recessed areas on the substrate, or areas with some level of random micro-roughness distinct from that of the untreated substrate surface, or areas with specific shapes designed to form a hologram or a diffraction grating or a surface that creates a color shifting effect after metallization.

The invention may also be carried out by treating the surface of the radiant barrier with processes that form an image without materially affecting the emissivity of the barrier. An image may be formed by printing the surface of the radiant-barrier material with a highly reflective paint that utilizes metal nanoflakes. Such nanoflakes lay flat in the paint layer, thereby creating a reflective layer with low emissivity comparable to that of the untreated barrier. Therefore, such images may be distributed over large portions of the barrier's surface without affecting its overall emissivity.

An image may also be formed on the surface of the radiant-barrier material using a transfer process where low-emissivity aluminum foil, metallized film, or transferable vacuum deposited aluminum. Because of the comparably low emissivity of such images, this process is also suitable for large area coverage.

Finally, the image may also be formed by embossing the surface of the radiant barrier material. The contrast created at the edge of the embossed areas forms visible images without materially affecting the emissivity of the barrier.

These visible images formed in radiant-barrier structures allow useful application/product information to be integrated into the radiant-barrier product without compromising the barrier quality and with no printed area limitation. In many cases, as detailed below, the presence of such images actually enhanced product performance.

Various other purposes and advantages of the invention will become clear from its description in the specification that follows and from the novel features particularly pointed out in the appended claims. Therefore, the invention consists of the features hereinafter illustrated in the drawings, fully described in the detailed description of the preferred embodiments and particularly pointed out in the claims.

### BRIEF DESCRIPTION OF THE DRAWINGS

FIG. 1 is a schematic cross-sectional representation of a basic form of the thermal radiant-barrier structure taught by this invention, including a substrate with a positive printed image (that is, an image formed by the printed area), a metallized layer over the substrate and printed image, and a protective and functional polymer layer.

FIG. 2 illustrates a negative image of that shown in FIG. 1 (i.e., the image is formed in areas where the substrate is not printed).

FIG. 3 is a schematic cross-sectional representation of a thermal barrier structure with an image formed by printing the whole substrate uniformly except in areas where the image is formed by printing with a different texture. For example, in these areas the print may be in the form of a micro-rough surface formed to contrast with the different uniformly printed rest of the surface. The micro-rough areas may be random or designed to interact with visible light to create a color shift as a function of viewing angle.

FIG. 4 illustrates in cross-section a radiant-barrier structure where the image is formed by printing over the substrate's surface, as in the case of FIG. 1, but in addition the printed area includes a micro-rough surface that may be random or designed to interact with visible light to create a color shift as a function of viewing angle.

FIG. 5 illustrates a radiant barrier where the image is formed by a thermo-forming or cold-forming process. The formed areas may have a flat surface or a micro-rough surface that is random or designed to interact with visible light to color create shift as a function of viewing angle.

FIG. 6 illustrates a radiant barrier with images formed on top of the protective polymer layer. Images may be formed by printing a reflective coating (a), by pattern metallization of the surface of the protective polymer coating (b), by forming the surface of the barrier sheet (c), or by transferring and attaching a reflective film or foil to the surface of the sheet (d).

### DETAIL DESCRIPTION OF THE INVENTION

The invention is based primarily on the discovery that images formed in radiant-barrier structures between the substrate and the reflective metal layer can produce correspondingly visible images on the opposite side of the metal layer without materially altering the emissivity of the radiant barrier. In fact, under certain conditions the emissivity is actually decreased. Therefore, such visible images provide a means to convey product and application information and to add visual effects with functional and/or decorative value that were heretofore impossible without substantially increasing the emissivity of the radiant barrier. In addition, it was discovered that similar results may be achieved by forming the images on top of the radiant-barrier structure.

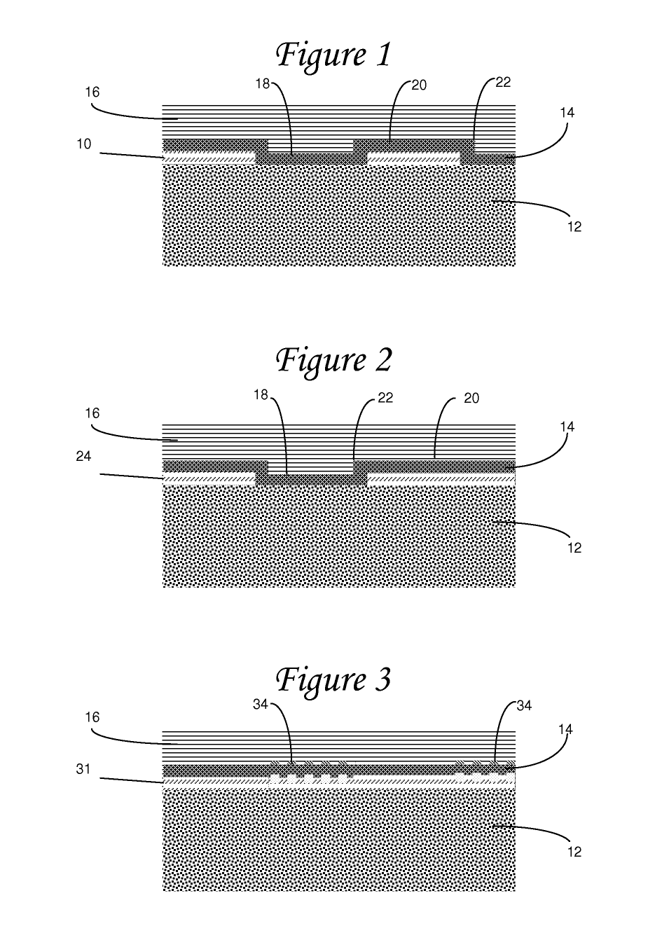

FIG. 1 illustrates a radiant-barrier structure according to the invention where an image 10 is printed with a conventional printing process onto a substrate 12. The printed substrate is then metallized with a metallic layer 14, which in turn is coated with a protective polymer layer 16. When the radiant-barrier sheet is viewed through the protective polymer layer, the difference in the surface texture of the metallized layer between the un-printed portions 18 of the substrate and the printed portions 20 thereof, as well as the contrast generated at the edge 22 of the printed image, creates a well defined image. The reflectivity (and emissivity) of the image area is a function of the substrate surface and the type of ink or coating printed to form the image. For example, when forming a visible image on a substrate with a relatively smooth surface, such as a polyethylene terephthalate (PET) polyester film, we found that an image printed with an ink or a coating formulation containing inorganic dyes with particle dimensions of the order of a few micrometers produces an image surface with a micro-roughness higher than that of the PET film, thereby rendering the image visible through the metal layer without increasing the emissivity of the surface (which in some cases can actually be decreased).

For relatively smooth substrates, the printed image needs to be as smooth as a clear lacquer coating to maintain the same level of emissivity as the metallized substrate. Organic color pigments are suitable for that purpose because they are molecular in size and do not affect the roughness of the printed surface. In cases where the substrate has some level of micro-roughness, a smoother image surface will actually lower the emissivity. Thus, for example, an aluminum-metallized 4-mil-thick polyethylene film with an emissivity ε=0.06 will show an emissivity decrease to ε=0.04 when printed with a relatively smooth surface image, such as with an organic pigment.

FIG. 2 illustrates a radiant-barrier structure where an image is provided on the substrate 12 with the same printing process of FIG. 1, but with the intent of forming the visible image, such as lettering, in the unprinted portions of the substrate. The printed substrate 24 is metallized with a metallic layer 14 and coated with a protective polymer layer 16, as in the barrier of FIG. 1. However, unlike the structure of FIG. 1, where the printing is carried out to provide recognizable images in the metallized printed areas 20, in the structure of FIG. 2 the printing is designed to form recognizable images in the areas 18 where there is no printing; that is, the negative of the image of FIG. 1. This approach is particularly useful in structures where the metallized printed substrate produces a lower emissivity than that of the unprinted surface. In such cases, if the image area is a small fraction of the total area, the performance of the radiant barrier will benefit from the printed image.

FIG. 3 illustrates s different structure where a substrate 12 is printed/coated across its whole surface with a layer 26 that is then metallized with a layer 14 and coated with a protective polymer layer 16. In this structure the image is formed by varying the thickness of the printed layer 26 in selected areas 28 designed to form images. Such varied thickness of the printed layer can be achieved in a conventional printing process including ink jet, screen printing, UV curing of 100% solids (printed directly or using a UV transmitting and patterned PET film in contact with the monomer solution), gravure, and offset gravure. In the latter three methods, the printing roll is designed to produce areas with uniform coating and others where the coating varies in thickness in a predetermined design. We found that the difference in thickness of the printed layer 26, which is reproduced in the surface of the uniform metallic film deposited over it, is sufficient to create the contrast necessary to obtain a visible image through the metallic layer. This structure is most suitable for applications where an improvement in the reflectivity of the radiant barrier may be obtained by the printed layer.

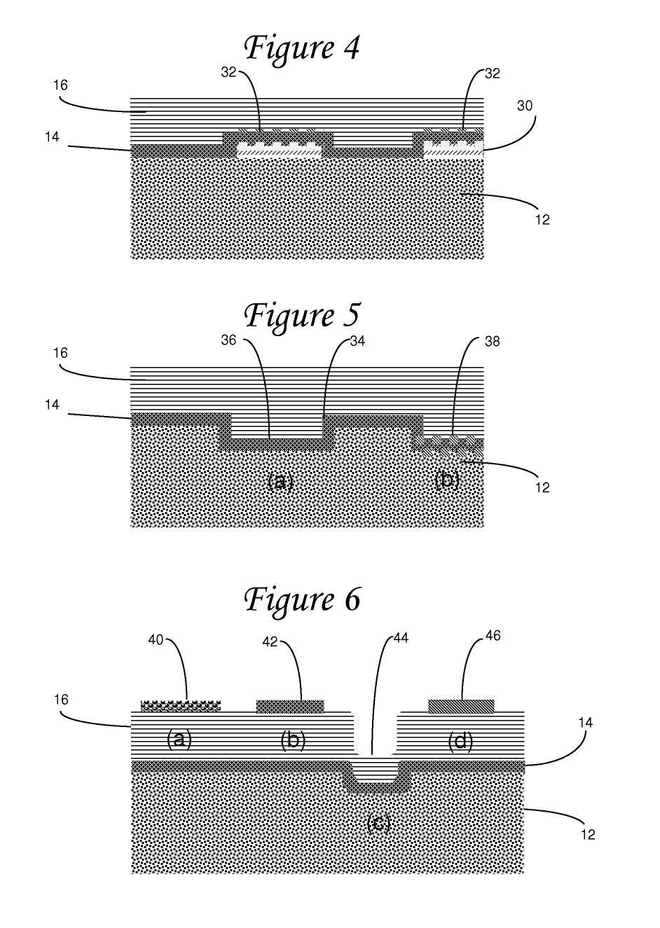

FIG. 4 illustrates a radiant-barrier structure where the image is formed by printing a layer 30 onto a substrate 12, as in the case of FIG. 1, but where the printed layer has a specific shape 32 intended to produce particular optical effects, such as a diffraction grating or a hologram, that can be used to authenticate the radiant-barrier product. One example of such a grating was produced by printing a sinusoidal coating on a polyester substrate with a period of 0.5 microns and an amplitude of approximately 0.7 microns. After metallization with aluminum with an optical density of OD=3.0 and coating of the aluminum with a protective polymer layer with a thickness of 0.2 micrometers, the surface of the printed coating exhibited a subtle color shift combined with a pearlescent white appearance. The emissivity of the color-shifting image was ε=0.04, while the emissivity of the metallized substrate was ε=0.035, an acceptable small increase for applications where such authenticating images may be desirable.

FIG. 5 illustrates a radiant-barrier sheet with two different image structures (a) and (b). In the portion of the figure identified as structure (a), an image 34 is produced by forming the substrate 10 via a cold or hot pressing process (embossing) that creates a permanent indentation prior to metallization. A metal layer 14 is then deposited on the substrate area followed by a protective polymer layer 16. The image is produced by the height difference (creating a step 34 at the edges of the image) and in some cases also the roughness difference between the recessed area 36 and untreated areas of the substrate's surface. When materials such as polymer films with a micro-rough surface, or non-wovens or foams, are used as substrates, the reflectivity in the pressed areas is usually higher than in the rest of the substrate, thereby creating the contrast that produces the image. In the portion of FIG. 4 identified as structure (b), the same principle is used, except that the pressed area has a pattern 38 that may be random or designed to form a diffraction grating or a hologram, with corresponding color-shifting effects, as explained above with reference to the barrier of FIG. 4.

FIG. 6 illustrates a radiant-barrier structure with four different types of images that we discovered can be formed on the exterior surface of the barrier without materially affecting its emissivity. Each of the images [denoted by (a), (b), (c) and (d) in the figure] is formed on top of the protective polymer layer 16. The structure of image (a) represents an image 40 printed on the protective layer 16 using a reflective metallic ink. Typically such ink includes a metallic flake, such as aluminum or copper. Using aluminum metal flakes produced by ball milling of aluminum particles, we found that the emissivity of such a printed surface can be as low as about ε=0.1. This can be very useful to improve the performance of a radiant-barrier substrate, such as a fabric or a porous material, that, when metallized, has a high emissivity. For radiant-barrier applications intended for commercial and residential housing, where the emissivity of the radiant barrier needs to be lower than ε=0.1 (and often lower than ε=0.05), we found that the best reflective coating (or ink) is one that includes an aluminum nanoflake derived from vacuum metallized aluminum layers that are reduced to aluminum flakes. Such inks are commercially available from several manufacturers (Sun Chemical Corp., for example). We found that an image printed using aluminum nanoflakes onto a metallized polyester radiant barrier had good contrast and an emissivity of 0.04, which was the same as that of the unprinted polyester barrier.

The structure of image (b) comprises a substrate 12, a metallized layer 14, a protective polymer layer 16, and a metallized image 42 on the surface of the protective layer. The metallized image is formed by vacuum metallizing a layer on top of the protective polymer layer and de-metallizing various sections to produce the image. Such de-metallization process can be performed inline with the metallization process using a mask that is printed onto the protective polymer layer, or it can be performed after the metallized layer is deposited over the whole surface of the radiant barrier material by etching some of the aluminum to form an image. Images formed by these techniques have about the same precision and resolution of an ink-printed image. When forming such images, we found that the contrast of the image is mainly a function of the difference in surface roughness between the substrate and the protective polymer layer. When both surfaces are equally flat, this image structure results in relatively poor contrast.

The structure of image (c) includes a substrate 12, a metallized reflective layer 14, a protective polymer layer 16, and an image area 44 formed by embossing the surface of the radiant barrier sheet. This is a relatively simple process that produces well defined images, but we found that the pressure and tooling used to emboss the surface have to be such that the protective polymer layer is not punctured so as to compromise the protection of the metallized layer. Note that the embossing is carried all the way through the substrate. When embossing radiant-barrier structures formed on flat substrate films, such as polyethylene and polyester, the emissivity that results from such an image structure increases generally by 1-2%. When embossing materials such as films with micro-rough surfaces and non-woven textiles, the emissivity of the image can be lowered significantly because the pressed area is flatter and has a higher level of reflection.

Finally, the structure producing image (d) includes a substrate 12, a metallized layer 14, a protective polymer layer 16, and an image formed by hot or cold stamping of a reflective layer 46 on the surface of the protective polymer layer 16. Such reflective layer 46 may be a metallized layer, such as aluminum, or an aluminum foil stamped and attached to the protective polymer layer using either a hot or a cold gluing process. We found that this image forming method does not compromise the reflectivity of the radiant-barrier material. The stamped image is at least as reflective and the rest of the radiant barrier surface. When substrates such as woven and non-woven textiles are used, the emissivity of the image area can be significantly lower than that of the rest of the substrate. For example, a non-woven polyethylene substrate was metallized and coated with a protective polymer layer that resulted in an emissivity of ε=0.12. When an aluminum-foil-based image was attached onto the non-woven radiant barrier material, the emissivity of the image was ε=0.034, which improved the emissivity of the overall radiant barrier material.

In applications where a woven or non-woven radiant-barrier material has to maintain a certain level of porosity and breathability, the image has to be designed in a manner that will minimize its impact on the overall properties of the base material. We found, for example, that a large image area may be obtained advantageously by breaking it down into closely spaced shapes (such as discs, triangles, etc.) that form the shape of the image but allow gas and vapor to pass through the base material.

Thus, a process has been disclosed that permits the formation of large images in a radiant-barrier structure without materially affecting its reflective effectiveness. The invention may be carried out with a variety of substrates including, without limitation, flexible materials such as polymer films, polymer and inorganic composites, paper, non-woven polymers, foam, vapor-transmitting and water-blocking films, micro-porous membranes, woven textiles, knitted textiles, aerogels, or combinations thereof.

While the invention has been shown and described herein in what is believed to be the most practical and preferred embodiments, it is recognized that departures can be made therefrom within the scope of the invention. For example, the invention has been described in terms of aluminum, but the various improvements described herein could be used with other reflective metals as well, such as with tin, copper, zinc, nickel, and silver. Thus, the invention is not to be limited to the details disclosed herein but is to be accorded the full scope of the claims so as to embrace any and all equivalent processes and products.

We claim:

1. A flexible radiant-barrier structure with a visible image on at least part of a surface of the structure, comprising:
a flexible substrate;
an image formed on a first side of the substrate;
a reflective metal layer deposited over said first side of the substrate; and
a protective polymer layer deposited over the reflective metal layer.

2. The radiant-barrier structure of claim 1, wherein the substrate includes a flexible material selected from the group consisting of a polymer film, a polymer and inorganic composite, paper, a non-woven polymer, a foam, a vapor-transmitting and water-blocking film, a micro-porous membrane, a woven textile, a knitted textile, an aerogel, or a combination thereof.

3. The radiant-barrier structure of claim 1, further including
an additional image formed on a second side of the substrate;
an additional reflective metal layer deposited over said second side of the substrate; and
an additional protective polymer layer deposited over said additional reflective metal layer.

4. The radiant-barrier structure of claim 1, wherein the image is formed using an ink or a coating.

5. The radiant-barrier structure of claim 4, wherein said ink or coating has a flat surface.

6. The radiant-barrier structure of claim 4, wherein said ink or coating has a random micro-rough surface.

7. The radiant-barrier structure of claim 4, wherein said ink or coating has a micro-rough surface with a pattern designed to interact with visible light to create a color shift as a function of a viewing angle.

8. The radiant-barrier structure of claim 1, wherein the image is formed by embossing the substrate to form a permanent indentation.

9. The radiant-barrier structure of claim 1, wherein said image has a lower emissivity than areas outlining the image.

10. The radiant-barrier structure of claim 1, wherein the substrate is porous to gas and vapor and the image includes multiple adjacent fractions of the image combined to form the image.

11. A flexible radiant-barrier structure with a visible image on at least part of a surface of the structure, comprising:
a flexible substrate;
a reflective metal layer deposited over the substrate;
a protective polymer layer deposited over the metal layer; and
an image formed on the said protective polymer layer.

12. The radiant-barrier structure of claim 11, wherein the substrate includes a flexible material selected from the group consisting of a polymer film, a polymer and inorganic composite, paper, a non-woven polymer, a foam, a vapor-transmitting and water-blocking film, a micro-porous membrane, a woven textile, a knitted textile, an aerogel, or a combination thereof.

13. The radiant-barrier structure of claim 11, further including
an additional reflective metal layer deposited over a second side of the substrate;
an additional protective polymer layer deposited over said additional reflective metal layer; and
an additional image formed on said additional protective polymer layer.

14. The radiant-barrier structure of claim 11, wherein the image is formed using a reflective ink or a reflective coating.

15. The radiant-barrier structure of claim 14, wherein said reflective ink or reflective coating include reflective pigments selected from the group of metallized polymers, metals, metal oxides, natural minerals, dyes, or combinations thereof.

16. The radiant-barrier structure of claim 14, wherein said reflective ink or reflective coating has a flat surface.

17. The radiant-barrier structure of claim 14, wherein said reflective ink or reflective coating has a random micro-rough surface.

18. The radiant-barrier structure of claim 14, wherein said reflective ink or reflective coating has a micro-rough surface with a pattern designed to interact with visible light to create a color shift as a function of a viewing angle.

19. The radiant-barrier structure of claim 11, wherein the image is formed by embossing the radiant-barrier structure to form a permanent indentation.

20. The radiant-barrier structure of claim 11, wherein said image has a lower emissivity than areas outlining the image.

21. The radiant-barrier structure of claim 11, wherein the image is formed by attaching reflective elements onto the protective polymer layer.

22. The radiant-barrier structure of claim 21, wherein said reflective elements include a metal foil or a metallized film.

23. The radiant-barrier structure of claim 11, wherein the substrate is porous to gas and vapor and the image includes multiple adjacent fractions of the image combined to form the image.

24. The radiant-barrier structure of claim 11, wherein the image is formed by the deposition of a metallized layer that is selectively demetallized to produce the image.
